(19) United States
(12) Patent Application Publication
(10) Pub. No.: US 2010/0156598 A1
(43) Pub. Date: Jun. 24, 2010

(54) RFID MEDICAL DEVICES AND SYSTEMS FOR READING PHYSIOLOGICAL PARAMETER

(76) Inventor: Ting Kwok LEUNG, Hong Kong (CN)

Correspondence Address: BYIP, LTD., P.O. BOX 1484, GENERAL POST OFFICE, HONG KONG, HK

(21) Appl. No.: 12/338,082

(22) Filed: Dec. 18, 2008

(51) Int. Cl. H04Q 5/22

(52) U.S. Cl. 340/10.1

(57) ABSTRACT

In the medical field, it is necessary to obtain physiological parameters, including temperature, heart rate, and blood pressure, from patients frequently. The devices involved generally require human operation (for example thermometer and sphygmomanometer), or continuous direct connection to large devices. All these do not only create discomfort to the patients, but also requires operation of these devices from medical staff, which translates into substantial labor hours. To resolve these issues, RFID medical devices capable to read physiological parameters are provided, such that less human operation can be involved, or the patients may be freed from continuous connections to large devices.

### FIELD OF THE INVENTION

This invention relates to RFID medical devices for reading physiological parameters from a patient, particularly temperature, heart rate, and blood pressure.

### BACKGROUND OF THE INVENTION

In the medical field, it is necessary to obtain physiological parameters from patients from time to time. In some cases, it may be necessary to obtain these parameters from a patient frequently, say every 30 or 60 minutes. These parameters include temperature, heart rate, and blood pressure. The devices involved generally require human operation (for example thermometer and sphygmomanometer). Further, devices like pulse meters require patients to be directly connected to large devices continuously. All these do not only create discomfort to the patients, but also requires operation of these devices from medical staff, which translates into substantial labor hours.

### OBJECTS OF THE INVENTION

Therefore, it is an object of this invention to resolve at least one or more of the problems as set forth in the prior art. Particularly, it is an objection of the current invention to provide medical devices that can read physiological parameters from a patient relatively conveniently. As a minimum, it is an object of this invention to provide the public with a useful choice.

### SUMMARY OF THE INVENTION

Accordingly, this invention provides a RFID medical device for reading at least one physiological parameter from a patient by a reader, the RFID medical device including:
at least one sensor for sensing said physiological parameter from the patient as a corresponding at least one sensed signal;
a RFID transmitter for transmitting said sensed signal to the reader in a contactless manner, said RFID transmitter electronically and cooperatively connected to said sensor.

Preferably, the physiological parameter is selected from the group consisting of body temperature, heart rate, and blood pressure, and said sensor is selected respectively from the group consisting of temperature sensor, heart rate sensor, and blood pressure sensor.

Optionally, the RFID medical device of the current invention also includes a plurality of said sensors for sensing a plurality of respective physiological parameters.

Preferably, the RFID transmitter has an operating voltage from 2V to 5V.

Alternatively, the sensor is a heart rate sensor having an operating voltage from 2V to 7V.

It is another aspect of this invention to provide a system for reading at least one physiological parameter from a patient including a RFID device of the current invention and a reader.

### BRIEF DESCRIPTION OF THE DRAWINGS

Preferred embodiments of the present invention will now be explained by way of example and with reference to the accompanying drawings in which:

FIG. 1 shows the block diagram of a RFID tag IC used in the medical devices of the current invention.

### DETAILED DESCRIPTION OF THE PREFERRED EMBODIMENTS

This invention is now described by way of example with reference to the figures in the following paragraphs. List 1 below is a part list so that the reference numerals in the figures may be easily referred to.

List 1

| Reference Numerals | Description |
|---|---|
| VDD | Positive power supply |
| VSS | Negative power supply |
| D7~D0 | Data select inputs |
| OSC1 | Oscillator input |
| OSC2 | Oscillator output |
| L1 | Coil input 1 |
| L2 | Coil input 2 |

Objects, features, and aspects of the present invention are disclosed in or are apparent from the following description. It is to be understood by one of ordinary skilled in the art that the present discussion is a description of exemplary embodiments only, and is not intended as limiting the broader aspects of the present invention, which broader aspects are embodied in the exemplary constructions.

In order to achieve the purpose of the current invention, medical devices using RFID (radio frequency identification) technologies are devised. RFID technologies are well known, and have been used widely in pre-paid cards, or as identification cards for security. As such, the principles and working of these RFID technologies will not be further discussed here.

Any suitable existing RFID tag ICs can be used for the current invention. RFID tag ICs can be used to emit suitable signals when it is connected to a sensor electrically and cooperatively. Different RFID tag ICs will have different connectivity layout. However, it would be apparent to the skilled person how to connect a sensor to these different RFID tag ICs according to, for example, the working manual of these ICs.

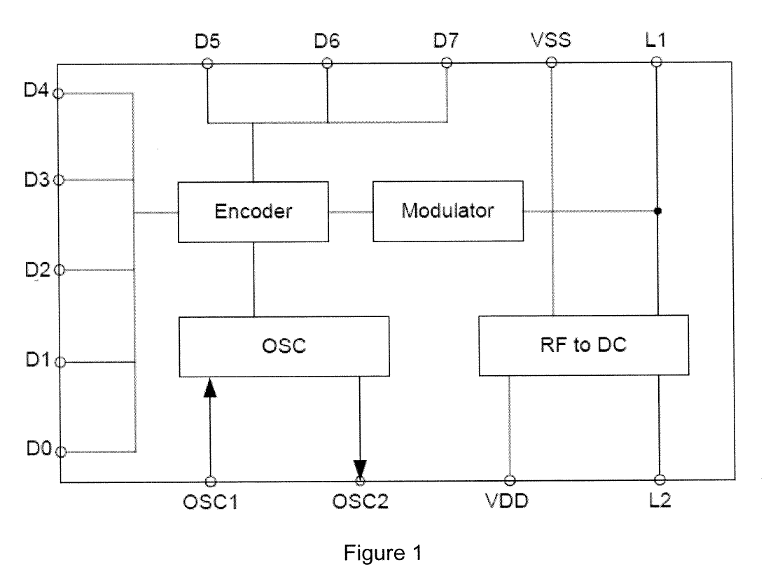

As an example, the block diagram of one such IC is shown in FIG. 1, which is sold by Sino Matrix Technology under model no. HL5230. HL5233 is the complimentary RFID Reader, which contains a 13.56 MHz crystal oscillator, a 13.56 MHz output buffer, a preamplifier and data decoder. The output buffer of the RFID reader drives an antenna which can transmits RF signal to the RFID tag IC.

As for other RFID devices and readers, when the tag IC is brought close to the reader, the encoder of the tag IC will send a signal for modulating the RF signal in the tag IC, and the amplitude of the RF signal in the reader. The preamplifier in the reader amplifies the modulating signal, while the decoder decodes the encoded data transmitted from the tag IC.

Although not necessary for the current invention to work, the following features of the tag IC HL5230 are advantages to the current invention low standby current; low power consumption simple application circuit; stable performance.

Suitable sensors should be connected to the RFID tag IC such that useful physiological parameters could be read by the reader. These sensors include temperature sensor, heart rate sensor, and blood pressure sensor.

Thermistors (thermal resistors) are one type of the suitable temperature sensors for the current invention, which are resistors with predictable and variable resistance with respect to changes in temperature. A positive temperature coefficient (PTC) device increases resistance in increases in temperature. A negative temperature coefficient (NTC) device decreases resistance in increases in temperature. Either PTC or NTC can be used for the medical devices of the current invention. As human body temperature is limited to a relatively narrow temperature range, it is preferred and easier to seek for PTC or NTC having relatively high linearity. As it may not be necessary to obtain continuous reading from these temperature sensors, these types of sensors can be connected the oscillator input and output of the RFID tag IC.

Heart rate and electrocardiogram (ECG) sensor can be a single chip differential-sensing electrocardiogram heart pulse detection system. One example of heart rate sensor is the model ST158 sold by Spark Technology Limited. A preamplifier is built into this sensor as a differential input instrument amplifier for preprocessing heart pulse signal from input sensors. With a built-in A/D converter, the analog heart pulse signal is sampled and digitized as digital signal for further processing by digital means. The internal digital processor tracks input digital signals and extracts out digital heart pulse signal by suppressing down noise signals which came with heart pulse signal from input sensors. There are two output formats of heart pulse signal: one is traditional single digital pulse form; the other is analog wave form of heart pulse signal. As continuous reading may be required from heart rate sensors, these types of sensors can be connected the data inputs of the RFID tag IC.

Strain gages can be used as blood pressure sensor, which are resistive elements with resistance proportional to an applied mechanical strain in either compression (a push along the axis toward the center) or tension (a pull along the axis away from the center). This kind of sensors can be used for the measurements of muscle forces and blood pressure.

Other sensors can also be used, provided that these sensors can be connected to a RFID tag IC electrically and cooperatively.

As noted above, it is possible to connect two different sensors to a single RFID. For example, the RFID tag HL5230 can connect to a temperature and a heart rate sensor ST158 above. If a different RFID tag is used, it is possible to connect more than two different devices. Apparently, the reader may have to be programmed in an appropriate manner in this case to read different signals from different sensors.

The medical devices comprising the sensors and the RFID tag can be packaged in a suitable form, for example, in a wearable with suitable fasteners like buckles, straps, or Valco™ for fastening to the patient. Accordingly, physiological readings can be read from the patient when necessary with less human operation, or even without the need of direct connection to various machines.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. A RFID medical device for reading at least one physiological parameter from a patient by a reader, including:
at least one sensor for sensing said physiological parameter from the patient as a corresponding at least one sensed signal;
a RFID transmitter for transmitting said sensed signal to the reader in a contactless manner, said RFID transmitter electronically and cooperatively connected to said sensor.

2. The RFID medical device of claim 1, wherein said physiological parameter is selected from the group consisting of body temperature, heart rate, and blood pressure, and said sensor is selected respectively from the group consisting of temperature sensor, heart rate sensor, and blood pressure sensor.

3. The RFID medical device of claim 2 including a plurality of said sensors for sensing a plurality of respective physiological parameters.

4. The RFID medical device of claim 1, wherein the REID transmitter has an operating voltage from 2V to 5V.

5. The RFID medical device claim 2, wherein the sensor is a heart rate sensor having an operating voltage from 2V to 7V.

6. A system for reading at least one physiological parameter from a patient including a RFID device of claim 1 and a reader.
